(19) United States
(12) Patent Application Publication
(10) Pub. No.: US 2017/0264175 A1
(43) Pub. Date: Sep. 14, 2017

(54) ENCLOSED-VENTILATED, ELECTRICALLY EXCITED SYNCHRONOUS MACHINE

(71) Applicant: Siemens Aktiengesellschaft, 80333 München (DE)

(72) Inventors: ANDREAS GRÜNTHALER, Nürnberg (DE); OLAF KÖRNER, Nürnberg (DE); JOHANN STAPFNER, Arnstorf (DE)

(73) Assignee: Siemens Aktiengesellschaft, 80333 München (DE)

(21) Appl. No.: 15/529,024

(22) PCT Filed: Nov. 18, 2015
(86) PCT No.: PCT/EP2015/076915

§ 371 Date: May 23, 2017

(30) Foreign Application Priority Data
Nov. 24, 2014 (EP) 14194534.5

(51) Int. Cl. H02K 19/02; H02K 3/18; H02K 9/06; H02K 1/24

(52) U.S. Cl. CPC H02K 19/02; H02K 1/24; H02K 3/18; H02K 9/06

(57) ABSTRACT

An enclosed-ventilated electrically excited synchronous machine includes a shaft and a rotor which is non-rotatably positioned on the shaft. The rotor includes a plurality of pole bodies which project radially outwards. The pole bodies have each an exciter coil and form in their entirety a rotor winding, with each pole body having an end face formed with a coil winding head. A protective element is provided on the coil winding head to protect the coil winding head against abrasion.

The invention relates to an enclosed-ventilated, electrically excited synchronous machine.

Enclosed-ventilated dynamo-electric machines, in particular electrically excited synchronous machines, by virtue of their construction and for thermal reasons, have a flow or air within the dynamo-electric machine, which to some extent is directed against the direction of movement of the rotating parts of this machine. This means that, especially at comparatively high relative speeds of the different parts of the machine, abrasion is produced, among other places, at the insulation of the coils on the pole bodies of the rotor. This is the case in particular when a dynamo-electric machine of this type is used in a dusty environment.

Previously protection for the exciter coils has been achieved by an elastic mass, e.g. silicon, being applied directly to the parts of the rotor windings affected by abrasion.

The disadvantage in such cases is that this leads to a poorer removal of heat, in particular of the coil winding head of the rotor. Likewise maintenance work, e.g. re-impregnating the winding of the rotor, can only be carried out with a comparatively high degree of effort.

Starting from this point, the object of the invention is to the create an enclosed-ventilated, electrically excited synchronous machine, which with sufficient heat removal and comparatively good accessibility of the individual machine parts, especially of the rotor for maintenance work, offers sufficient protection from abrasion.

The desired object is successfully achieved by an enclosed-ventilated, electrically excited synchronous machine with a rotor, which is non-rotatably positioned on a shaft, wherein the rotor has a rotor winding with individual exciter coils, each coil being arranged around a pole body, wherein a coil winding head is formed on each of the end faces of the pole body, wherein a protective element is provided for each coil winding head, which element protects the coil winding head against abrasion.

In this document an enclosed-ventilated, electrically excited synchronous machine is to be understood as a synchronous machine that can be electrically excited via coils of the rotor. The coils in this case are supplied with electricity via slip rings or via the brushless exciter devices known per se. At least one inherent fan and/or at least one external fan create one or more cooling flows of air through the machine by means of air from the environment.

The protective elements are attached such that the coil winding heads of the winding of the rotor are protected from abrasion. This is guaranteed in particular when the protective elements, viewed in the direction of rotation of the rotor, are attached in front of the coil winding heads in each case.

Depending on the environmental conditions and the speed of rotation of the machine, the protective elements are made of metal (steel or aluminum) or of plastic.

Individual protective elements made of plastic or protection facilities manufactured in one piece (one protective element per pole body, which are arranged on a common ring) are light and easy to manufacture, so that the inertia of the armature is only changed to a slight extent by the protective elements or by the protection facility.

The protective elements or the protection facilities made of plastic are able to be manufactured in a simple manner, e.g. in an injection-molding process.

The protective elements designed as metal elements are also able to be manufactured as individual elements or as a protection facility. In such cases a casting process is suitable, followed if necessary by machining away of at least part of the metal during post-processing of predetermined surfaces, such as e.g. the shaft seat of the protection facility.

The positioning of the protective elements on the rotor will be particularly simple if all protective elements of a rotor winding embodied accordingly are located on a ring, which then merely has to be positioned on a shaft and arranged non-rotatably, in order to protect the coil winding heads in this way. The construction will be particularly simple in such cases if both ring and also the individual protective elements of the respective pole bodies of the rotor are available as one-piece material. Accordingly its own protection facility is to be provided for each armature diameter and number of poles of the armature.

By contrast individual protective elements are universally applicable, since each individual pole body will be provided with its protective element.

In this further embodiment the protective elements are available individually and can be fixed to the pole body of the rotor by fastening facilities embodied accordingly, such as snap-on connections, clamping facilities, screw connections etc. This has the advantage that, regardless of the number of the poles of the rotor, no separately designed construction with a ring has to be provided, but appropriate protective elements are merely allocated to the respective pole body.

In order to design protection from abrasion especially advantageously the protection elements are embodied in the shape of shells. In such cases the geometrical design of the protective elements is such that, viewed in the direction of rotation, approx. the first half of the coil winding head is covered. This is especially advantageous for enclosed-ventilated, electrically excited synchronous machines with only one direction of rotation, since despite these protective elements designed in this way, a cooling effect is produced at the coils of the rotor.

Advantageously fastening means are provided on each protective element, in order to fit further elements to the protective elements. These are for example fan blades and/or balancing weights, which allow a subsequent balancing of the rotor to be undertaken.

In a further form of embodiment the protective elements are provided with a curvature on their radially-outer edge, which diverts an essentially radial flow of air along the protective elements essentially axially and in this way guides it away from the end face of the rotor. This embodiment of the protective element avoids a radial flow of air with the particles being carried onto the winding head of the stator and leading to abrasion problems there.

Advantageously a machine of this type with shell-shaped protective devices is only designed for one direction of rotation. This is especially advantageous for generators that will be driven by diesel engines, such as e.g. on locomotives, multiple units, mining trucks or ships.

Depending on the material of the protective elements, a gap is provided between protective element and winding head, which contains the insulating spaces and in addition meets the technical cooling requirements. Preferably in this case a flow of cooling air with decelerated particles will be carried in the gap between protective element and the surface of the coil.

The protective elements are sufficiently spaced apart, when the air gaps, i.e. the insulation spacings, are adhered to and a further air guidance can take place in this gap free from particles of high kinetic energy.

Through the inventive embodiment of the abrasion protection of the winding of the rotor, especially of the coil winding heads by the protective elements or protection facility, the axial air mass flow through the pole gaps is not restricted. This further guarantees a maximum cooling power of the coil sides and thus of the coils of the rotor.

The invention, as well as further advantageous embodiments of the invention, is to be taken from the exemplary embodiments shown below. In the figures:

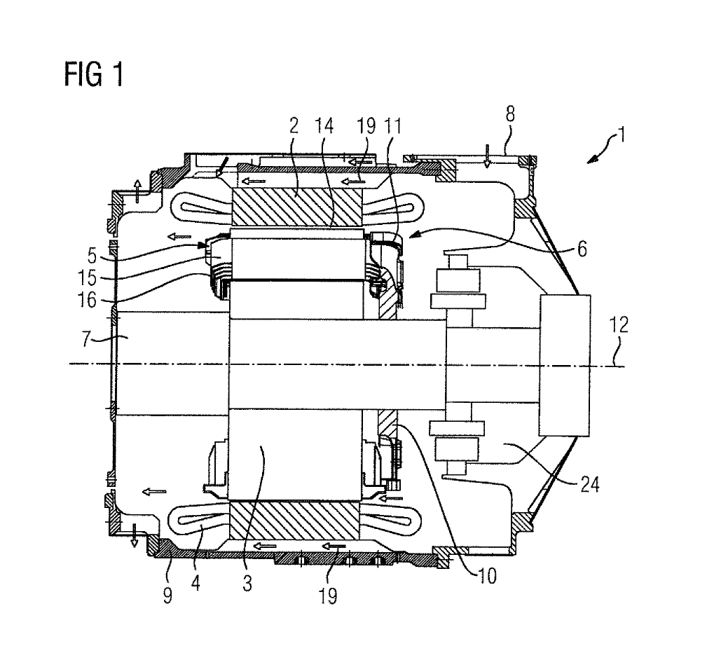

FIG. 1 shows a longitudinal section of a permanently excited synchronous motor with enclosed ventilation,

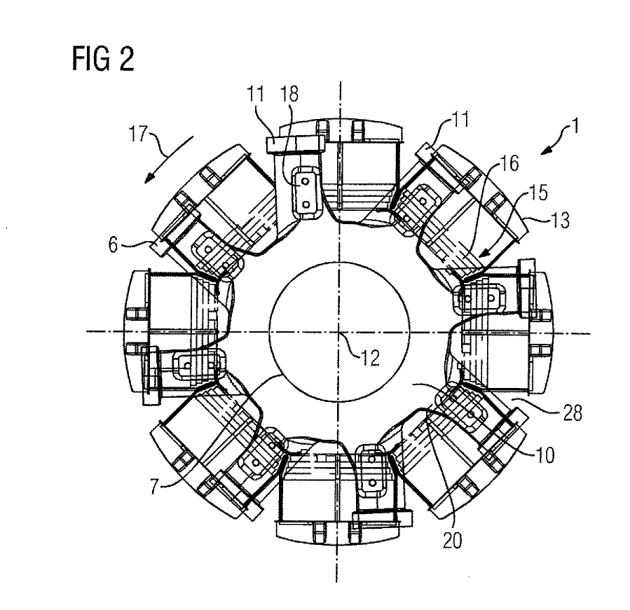

FIG. 2 shows a side view of an armature,

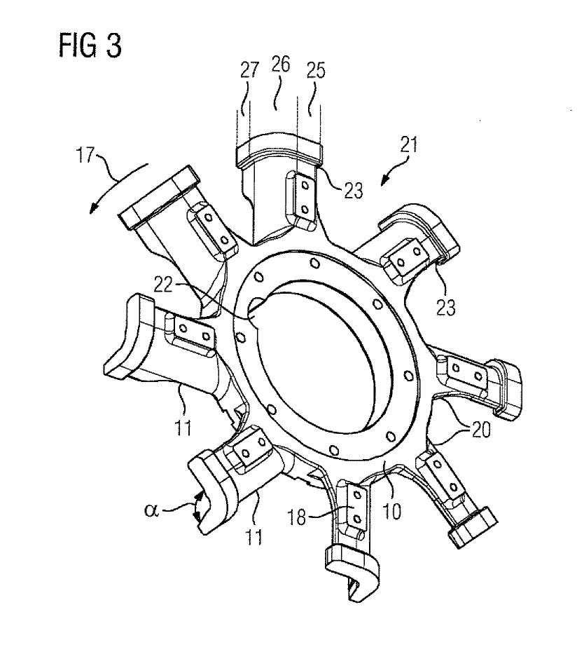

FIG. 3 shows a perspective diagram of the abrasion protection.

FIG. 1 shows an enclosed-ventilated, electrically excited synchronous motor 1 in a longitudinal section with a stator 2 and a rotor 3. A stator winding head 4 is present on the end faces of the stator 2. The rotor 3 has pole bodies 13 projecting radially outwards, each of which is provided with an exciter coil 15 and which in their entirety form a rotor winding 5. The exciter coils 15 are supplied with electrical power via a slip ring arrangement or a brushless exciter device not shown in any greater detail.

In this figure coil winding heads 16 of these exciter coils 15 can be seen on the end faces of the rotor 3. The rotor 3 is positioned non-rotatably on a shaft 7, which rotates around an axis 12. Through electromagnetic interaction of the winding systems of stator 2 and rotor 3 across the air gap 14, the dynamo-electric machine will be operated as a motor or as a generator.

The ambient air will be used for cooling this electrical synchronous machine 1, so that for example cooling air will be carried via a connector 8 into the interior of the synchronous machine 1. These flows of cooling air 19 will be distributed within the machine and flow inter alia via cooling channels in the stator 2, the rotor 3, the pole gaps 28 of the rotor 3 and the air gap 14.

Because of the speed of the flow of air, the particles carried inwards with said flow from the outside and the simultaneous comparatively high relative speed of the rotor 3 and thus of the rotor winding 5 in relation thereto, abrasion of the insulation of the coil winding head 16 of the exciter coils 15 and thus of the rotor winding 5 occurs at unfavorable sections of the coil winding head 16. In order to avoid this, protective elements 11 are provided in accordance with the invention as abrasion protection 6.

This can also be seen in FIG. 2 for example, where the protective elements 11 are arranged on a ring 10 and thus form a protection facility 21. The protective elements 11 are arranged on arms 20 of this ring 10 extending radially. The protective elements 11, viewed in cross section, are embodied in the shape of a shell and thus, viewed from the air gap 14, form an angle α of 90°. The angle α of a protective element 11 can however, depending on application, be embodied between 60 and 150°. In the direction of movement 17 of the armature or rotor 3 almost no air particles can strike the insulation of the coil winding head 16 and damage the insulation. The insulation is accordingly protected, which lengthens the service life and the maintenance intervals of the enclosed-ventilated, electrically excited synchronous machine 1.

Of course the protective elements 11 are also able to be attached individually to the pole body 13, which likewise includes the advantages mentioned above in relation to protection of the insulation of the winding of the rotor 3 and of the coil winding head 16.

FIG. 2 additionally shows an eight-pole rotor 3 with its pole bodies 13, around which an exciter coil 15 is laid in each case. In the direction of movement 17 in this case the protective elements 11 are now arranged on a central ring 10. The protective elements 11 are provided with means 18 that allow fan blades and/or balancing weights to the fastened to them.

These means 18 will be embodied as well during manufacturing—i.e. a casting process—of the protective element 11 or the protection facility. If necessary post-processing of these means 18, or of other surfaces of the protective element 11 or of the protection device 21, such as milling or drilling, is necessary.

FIG. 3 also shows a recess 22 of the ring 10, via which an electrical connection is made between slip ring body or a brushless exciter facility and the exciter coils 15 of the rotor 3.

In accordance with FIG. 3 a curvature 23 is provided on the radial outer end of the protection elements 11, which essentially deflects an essentially radial flow of air axially and in this way guides it away from the end face of the rotor 3. This embodiment of the protective element 11 avoids a radial flow of air with the particles contained therein striking the stator winding head 4 and leading to abrasion problems there on the insulation located there.

Advantageously the section of the protective element 11 that screens off the coil winding head 16 of the rotor 3 with its arm 20 is essentially embodied as follows. Regardless of whether it is embodied as a part of a protection facility 21 with ring 10 or will be positioned individually on the pole body 13, the protective element has three sections 25, 26, 27. Section 25 essentially runs in parallel to the end face of the rotor 3 and has the means 18. Section 26 is characterized by a bend, which is adjoined above all in the radially-outer area of the protective element 11 by a section 27, which essentially extends in the direction of pole gap 28.

The angle α in this case is essentially created by the bend in section 26.

Such abrasion protection 6 of an enclosed-ventilated electrically excited synchronous machine with shell-shaped protective elements 1 is preferably suitable for one direction of rotation. This is in particular advantageous for generators that will be driven by diesel engines, such as e.g. on locomotives, multiple units, mining trucks or ships.

For enclosed-ventilated electrically excited synchronous machines 1 for both directions of rotation, two shells are to be provided per coil winding head 16 for example, each with approx. 90°, or one shell will be used as a protective element 11 with approx. 180°, which thus has more of a tray-shaped structure.

1.-8. (canceled)

9. An enclosed-ventilated electrically excited synchronous machine, comprising:
a shaft;
a rotor non-rotatably positioned on the shaft, said rotor including a plurality of pole bodies projecting radially outwards, said pole bodies having each an exciter coil and forming in their entirety a rotor winding, each said pole body having an end face formed with a coil winding head; and
a protective element provided on the coil winding head to protect the coil winding head against abrasion.

10. The enclosed-ventilated electrically excited synchronous machine of claim 9, further comprising a ring connected non-rotatably to the shaft, said protective element being arranged on the ring.

11. The enclosed-ventilated electrically excited synchronous machine of claim 9, wherein the protective element is positioned on the pole body such as to establish a predetermined air gap between the protective element and the coil winding head.

12. The enclosed-ventilated electrically excited synchronous machine of claim 9, wherein the protective element has a shell-shaped configuration.

13. The enclosed-ventilated electrically excited synchronous machine of claim 9, wherein the protective element is configured for attachment of a balancing weight and/or fan blade.

14. The enclosed-ventilated electrically excited synchronous machine of claim 9, further comprising a stator having a winding head, said protective element having a curved radial outer edge to divert a radial flow of air in an essentially axial direction away from an end face of the rotor to avoid abrasion at the winding head of the stator.

15. The enclosed-ventilated electrically excited synchronous machine of claim 9, constructed to only rotate in one direction of rotation under normal operating condition.

16. A drive or an electric generator of a ship, a locomotive a mining truck or another electrically-driven vehicle, comprising an enclosed-ventilated electrically excited synchronous machine including a shaft, a rotor non-rotatably positioned on the shaft, said rotor including a plurality of pole bodies projecting radially outwards, said pole bodies having each an exciter coil and forming in their entirety a rotor winding, each said pole body having an end face formed with a coil winding head, and a protective element provided on the coil winding head to protect the coil winding head against abrasion.

17. The drive or electric generator of claim 16, wherein synchronous machine includes a ring connected non-rotatably to the shaft, said protective element being arranged on the ring.

18. The drive or electric generator of claim 16, wherein the protective element is positioned on the pole body such as to establish a predetermined air gap between the protective element and the coil winding head.

19. The drive or electric generator of claim 16, wherein the protective elements has a shell-shaped configuration.

20. The drive or electric generator of claim 16, wherein the protective element is configured for attachment of a balancing weight and/or fan blade.

21. The drive or electric generator of claim 16, wherein the synchronous machine includes a stator having a winding head, said protective element having a curved radial outer edge to divert a radial flow of air in an essentially axial direction away from an end face of the rotor to avoid abrasion at the winding head of the stator.

22. The drive or electric generator of claim 16, wherein the synchronous machine is constructed to only rotate in one direction of rotation under normal operating condition.
